(19) United States
(12) Patent Application Publication
(10) Pub. No.: US 2009/0103789 A1
(43) Pub. Date: Apr. 23, 2009

(54) DELIVERING AND RECEIVING MEDICAL IMAGES

(75) Inventors: John E. Danner, Cincinnati, OH (US); Daniel P. Braga, Cincinnati, OH (US); Michael D. O'Brien, Cincinnati, OH (US)

Correspondence Address: WOOD, HERRON & EVANS, LLP, 2700 CAREW TOWER, 441 VINE STREET, CINCINNATI, OH, 45202, US

(73) Assignee: PROSCAN IMAGING, LLC, Cincinnati, OH (US)

(21) Appl. No.: 11/876,807

(22) Filed: Oct. 23, 2007

(51) Int. Cl. G06K 9/00

(52) U.S. Cl. 382/128

(57) ABSTRACT

A method, apparatus, and program product are provided for delivering and receiving DICOM images. A plurality of files, including DICOM image files and non-DICOM image files, stored on a computer is accessed. The DICOM image files are identified from among the plurality of files by scanning header data of the plurality of files when accessing the plurality of files. At least one of the identified DICOM image files is selected to be uploaded in response to user input. The selected DICOM image file is uploaded to an application on a server.

### FIELD OF THE INVENTION

The present invention relates, generally, to medical image records, and, more particularly, to modifying and transmitting DICOM image files with medical information to at least one or more sources.

### BACKGROUND OF THE INVENTION

Medical imaging has made a significant contribution to improvements in diagnosing and treating many injuries and illnesses. There are many different types of medical imaging available including X-ray imaging, magnetic resonance imaging, computerised tomography, ultrasonic scanning, endoscopic imaging and nuclear imaging. As medical imaging techniques are continuously improving and evolving, physicians are able to provide patients with more informed diagnoses and more effective treatments and recovery plans. Patients who require specialist advice are, in many cases, able to present a copy of their medical images at an appointment with the specialising physician. There are also occasions where treating physicians, even specialists, have a need to share medical images with colleagues for an opinion or diagnosis. These colleagues may be located in other medical facilities, which may also be located in other locations of the country or even overseas.

As communications technology has developed, it has now become possible to pass vast quantities of information including images and accompanying data from one location to another over communications networks such as telephone networks and dedicated high speed communications networks. This technology facilitates sharing of medical information and images between physicians, where compatible communication platforms and protocols are used, as well as where common network connections are available.

Devices used to create and store different types of medical images usually differ from one another and devices that create digital records of the images often use different file formats and different protocols to compress and de-compress the image data. To overcome these differences, the Digital Imaging and Communications in Medicine (DICOM) standard was developed to meet the needs of users and manufacturers of medical imaging equipment for interconnection of devices on standard networks including the Internet. DICOM has become the most common standard for receiving digital medical images such as scans from a hospital. A primary advantage of the DICOM standard is that a piece of medical equipment or software produced by one manufacturer can communicate with software or equipment produced by another. Therefore, DICOM image data can be utilised by any party with access to a DICOM compatible viewer.

In addition to medical images, the DICOM image format provides for the entry of brief patient histories, usually by the technologist, and may also provide a patient work-list by the technologist that includes patient history and/or physician information.

The transmission of DICOM image files that are transmitted in a DICOM communication session may often include various errors, including data errors and data format errors, which complicate one's ability to receive and process a DICOM image file. Moreover, certain older CT and MRI devices may incorrectly populate DICOM data fields. Too often, discovery of such errors occurs during processing of a DICOM image file, which contributes increased frustration and associated costs. Often, similar or the same errors are repeated by the same sending DICOM service class user. Similarly, the data structure for the filing of patient studies may vary from site to site, making data transport challenging and often having to involve non-medical related parties such as system administrators to complete the transfer.

Under current HIPAA standards and with regard to other aspects of patient confidentiality, secure transmissions of the patient data are required. In many cases secure private networks, such as VPNs are utilized between the facilities sharing the medical images in order to preserve patient confidentiality and meet HIPAA requirements, thus limiting the ability to share image files.

What is needed therefore is a method to deliver and receive DICOM image files, without the need for a secure private network connection or intervention by non-medical parties.

### SUMMARY OF THE INVENTION

Embodiments of the invention provide a method, apparatus and program product for delivering and receiving DICOM images. A plurality of files stored on a computer are accessed, where the plurality of files include DICOM image files and non-DICOM image files. The DICOM image files are identified from among the plurality of files by scanning header data of the plurality of files when accessing the files. At least one of the identified DICOM image files is selected to be uploaded in response to user input. The selected DICOM image file is uploaded to an application on a server. Prior to uploading, in some embodiments, a header of the selected DICOM image file may be modified. In some embodiments, a DICOM C-STORE command may also be executed on the selected DICOM image file after modifying the header and prior to uploading. Notification may be received that the selected DICOM image file has been uploaded to a server and in some embodiments a representation of the DICOM image may be displayed by the application on the server. In other embodiments, after receiving notification, DICOM image file header data associated with the uploaded DICOM image file may be modified and the DICOM image file may then be downloaded to a local system.

In some embodiments, DICOM image files may be identified by reading header information, which includes metadata, of a file of the plurality of files. The metadata may be checked for a DICOM prefix. If a DICOM prefix is found in the metadata, the file is identified as a DICOM image file. In a specific embodiment metadata read from the header information may be used to extract additional descriptive information. The descriptive information may then be presented for each of the identified DICOM image files. Other embodiments may group the identified DICOM image files by a study identification extracted from the metadata and then present the identified DICOM image files by their group. DICOM image files may be further grouped by a series identification extracted from the metadata presented by series. The descriptive information includes but is not limited to information consisting of patient identification, patient name, patient date of birth, type of image file, series identification, series description, study identification, image identification, and combinations thereof.

In some embodiments, uploading the selected DICOM image file may be performed by transmitting the selected DICOM image file over a secure network connection. In a particular embodiment, an application executing on the server is a web application and the transmission of the DICOM image file to the application uses HyperText Transfer Protocol, secured. Other embodiments may use a secure network connection such as a secured socket layer (SSL) of a TCP/IP protocol.

Embodiments receiving DICOM images files may receive notification that a DICOM image file has been uploaded to an application on a server. The uploaded DICOM image file may then be accessed. In some embodiments, accessing the uploaded DICOM image file may include displaying a representation of the DICOM image by the application on the server. In other embodiments, accessing the uploaded DICOM image file may include modifying DICOM image file header data associated with the uploaded DICOM image file and then downloading the DICOM image file to a local system. In a particular embodiment, a DICOM C-STORE command may be executed on the downloaded DICOM image file on the local system allowing the downloaded DICOM image file to be displayed on the local system.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the principles of the invention.

FIG. 1 is a diagram representing a computing environment suitable for implementing DICOM image transfer consistent with embodiments of the invention.

FIG. 2 is a flowchart illustrating an embodiment for uploading DICOM images to a server in the environment of FIG. 1.

FIG. 3 is a hierarchical representation of a series of DICOM image files suitable for processing the environment of FIG. 1.

FIG. 4 is a flowchart illustrating an embodiment for manipulating DICOM images in the environment of FIG. 1.

FIG. 5 is a flowchart illustrating an alternate embodiment for manipulating DICOM images to that of FIG. 4.

FIG. 6 is a flowchart illustrating an embodiment for downloading and viewing DICOM images in the environment of FIG. 1.

### DETAILED DESCRIPTION

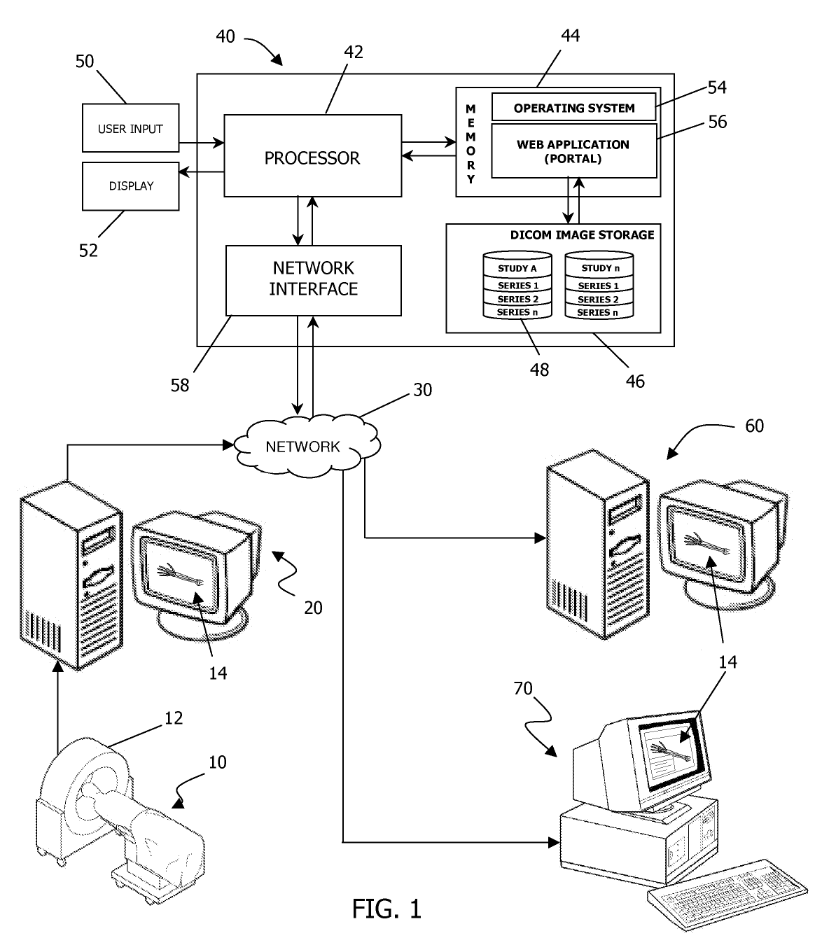

Embodiments of the invention provide a method, apparatus, and program product, which facilitate the delivery and receipt of DICOM image files. Turning to the drawings, wherein like numbers denote like parts throughout the several views, FIG. 1 illustrates an exemplary hardware and software environment suitable for delivering and receiving DICOM image files consistent with the invention. A patient 10 may be at a medical facility undergoing a medical procedure 12, such as an X-Ray, CT Scan, or MRI, for a medical problem associated with his/her wrist, for example. The images 14 generated from the medical procedure may then be sent to an apparatus 20 for storage and viewing by a medical professional such as a doctor or other specialist. For the purposes of the invention, apparatus 20 (and other similar apparatuses 40, 60, 70) may represent practically any computer, computer system, or programmable device e.g., multi-user or single-user computers, desktop computers, portable computers and devices, handheld devices, network devices, mobile phones, etc. Apparatus 20 will hereinafter be referred to as a “computer” although it should be appreciated that the term “apparatus” may also include other suitable programmable electronic devices. Images 14 may be stored on computer 20 in a format compatible with the DICOM standard for easy transport to other facilities and other systems, such as computers 60, 70, over network 30, which may be a private high speed network in some embodiments, or may be the Internet in other embodiments.

### Embedded Browser Control and DICOM Image Upload

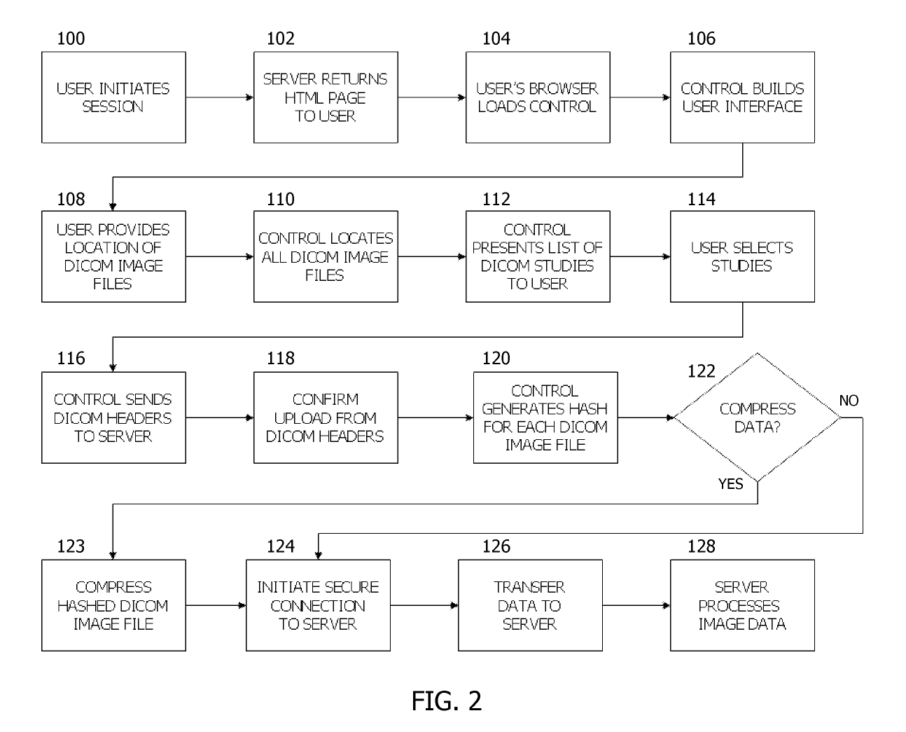

Referring to the flowchart in FIG. 2, an embodiment of the invention provides an embedded browser control for locating, sorting, selecting, compressing, validating, and securely transferring DICOM image files from a local system, such as computer 20 to a central web portal operating on a server, such as the web application 56 executing on computer 40 shown in FIG. 1.

In this embodiment, a user requests a session from the server in block 100. The server responds with an HTML page for the user's browser to load in block 102. Contained in the HTML page is a request for the browser to load an embedded control in block 104. Once loaded, the control may provide a simple user interface for the user to locate DICOM images in block 106. This may be accomplished, in some embodiments by a button displayed in the browser labeled ‘Find Images’, though other methods may be used in other embodiments to initiate a search for DICOM images. Once clicked, a window may appear with a list of available drives and directories. The user may then select a drive or directory where he or she believes DICOM image files reside in block 108. The control may then begin a recursive search on the selected drive or directory looking at each file. DICOM image files may be differentiated over non-DICOM image files by examining a header in each of the files. Those files containing a four byte DICOM prefix “DICM” in the header are determined to be DICOM image files in block 110. This method bypasses the need for the traditional DICOMDIR file, which generally contains file locations and description information of DICOM image files.

DICOM image files located from the drive/directory search may then be sorted into DICOM studies for presentation to the user in block 112. Embodiments of the invention may present the user with a list of the DICOM studies, representing the studies with data from fields extracted from the DICOM headers. The fields shown may be based on a configuration sent by the server. The user may then be asked to select a study or studies to send to the server in block 114. Additionally, in some embodiments, the user may be able to attach relevant non-DICOM files or documents to a study, for example a prescription for the exam, patient history records, etc. Once satisfied with the selected data the user, the user may, in some embodiments, initiate the sending of the images and files by clicking on a ‘Send File Now’ button displayed in the browser.

The control may then read each image and create and send the DICOM headers to the server in block 116. The uploaded data may be used to verify that the image is to be sent before actually uploading the large amount of image data in block 118. For example, a group may be running a clinical trial that requires only MRI images to be uploaded. A user may access the server and select a CT image file to upload. The header for the image would be uploaded and at that time, it would be determined that the type of file is not in compliance with the clinical trial, and therefore the actual image file, which may be on the order of 600 MB or more will not be uploaded. This process can save both time and costs when transferring and sharing images.

To verify and maintain the integrity of the image files transmitted to the server, the control in some embodiments may create an MD5 hash of the data in block 120. If the configuration sent by the server to the control includes a compression step (“yes” branch of decision block 122), then the data may be compressed using compression tools, such as the G-ZIP compression method, which has a compression ratio of approximately 50% for DICOM image files in block 123.

The control now connects to the remote server via a secure connection such as a Secure Socket Layer TCP connection (SSL) in block 124. This connection may be encrypted using a public key infrastructure (PKI). The images and files are sent via the secured socket to the server in block 126. The web application software on the server accepts each image. The server then uncompresses the data if it had been compressed before being sent and runs an MD5 check on the uncompressed data to verify that the hash value matches the value sent by the client in block 128.

In some embodiments, the control may operate in a two-phase manner. Phase 1 addresses the locating, sorting, and selecting phase of the above process. Phase 2 addresses the compression, validation, and secure transfer of the data. This two phase operation may allow the server to read DICOM header data and execute other user and internal processes prior to accepting the images, for example getting a credit card from the user and charging based on the exam type, which may be determined from information read from the DICOM header.

When uploading a study in some embodiments, the control may analyze specific DICOM header values from each DICOM image to verify that the header values meet a pre-defined standard. These values may include any data element that is part of the DICOM standard as well as private defined tags. The control may then present back to the user the checks that were performed as well as the results of each check. Examples of elements that may be checked are: Slice Thickness, Slice Separation, Echo Time, etc. All of these elements may be used as indicators as to the protocol used when performing the exam.

### DICOM Image Header and Series Management

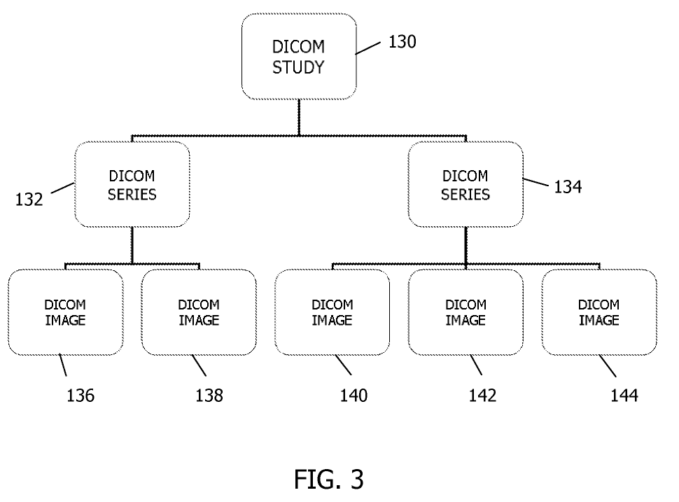

As seen in FIG. 3, DICOM studies 130 may be comprised of one or more DICOM series 132, 134. DICOM series may have one or more DICOM images 136-144. Each series has characteristics such as a name, a number, etc. A DICOM image file consists of a number of attributes, including one special attribute containing the image pixel data. Each of these attributes may be further defined in metadata in the header of the image file. Each DICOM image contains header information that describes the image including the series identification and description and the study identification to which it is a part. In addition to the study and series information, the header may contain other metadata including but not limited to patient identification, patient name, patient date of birth, type of image file, image identification, among others.

As described above, a user may have a need to change the series or study to which a DICOM image belongs to conform to the filing scheme of a remote location to which the DICOM images are being sent. There may also be a need to create new studies or series and move images into these new series. For example, if a physician orders a scan of a chest and an abdomen of a patient, a tech performing the scan may perform one continuous scan due to the proximity of the two scans ordered. Upon receiving the scanned images, the ordering physician may need to split the images for the chest and abdomen into separate series or studies before sending images on to other facilities or other colleagues. Additionally, there may be a need to modify the DICOM image headers to remove patient information, thereby making the DICOM images anonymous. This would allow treating physicians to send DICOM images to other colleagues for input without having to reveal the patient's identity.

Embodiments of the invention allow a user to interact with a GUI to modify the characteristics of the series and other header information in the DICOM image files. Embodiments allow the user to move images from one series to another or to create a new series as described above. This step may be necessary based on the protocol used when the study was created.

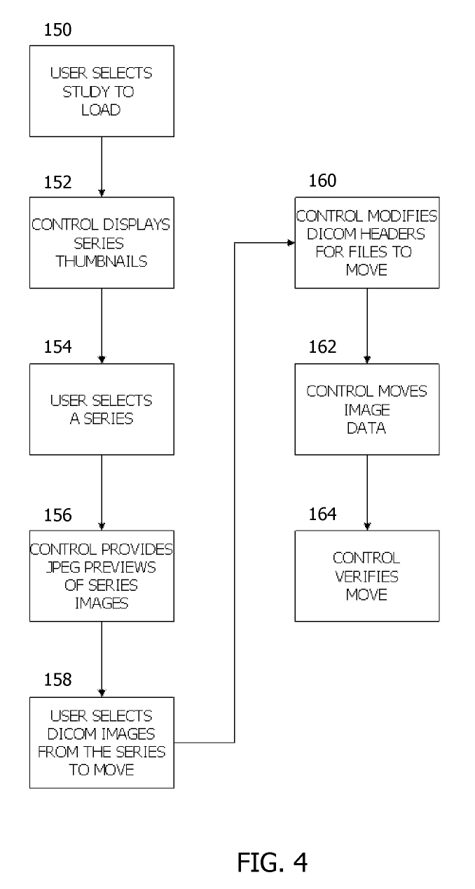

FIG. 4 is a flowchart of an embodiment for moving DICOM image files between series in a study. Referring now to the flowchart in FIG. 4, a user selects a study or studies in block 150. A control running in a browser may then convert the associated DICOM image files into snapshots in, for example, JPEG format, and present the user with a preview of each series in block 152. Other embodiments may utilize image file formats other than JPEG, such as, but not limited to, GIF, TIFF, PNG, BMP, etc. DICOM image files are identified and sorted in to study/series grouping using the finding process described above in relation to FIG. 2. After previewing the JPEG snapshots in the series, the user may select the series by clicking on the series preview image, which may also includes the series name in block 154. Once a series is selected, the user may then be presented with a thumbnail of each image in the series in block 156.

If, for example, the user wants to move images between series or studies, the user may select the thumbnails of the images presented in block 158. After the images have been selected, the user, in some embodiments, may select a ‘Move Images’ button displayed in the browser. In some embodiments, the user is then presented with a dialog asking the user for the series to move the images into. At this point the user may select an existing series or may create a new series. In the case of an existing series, values are set to match the target series. For new series values are set based on a simple algorithm. In other embodiments, moving the images may be performed by graphically dragging and dropping the images into a new series displayed within the user's browser.

The control then loads each original DICOM image file and modifies the following DICOM headers: SeriesDescription, SeriesNumber, and ImageNumber in block 160. The server may then physically move the files to a location consistent with the new series in block 162. Verification of the move is performed by the server in block 164. After the DICOM image files are modified, any outside system that reads the image files will believe that these images are now in another series.

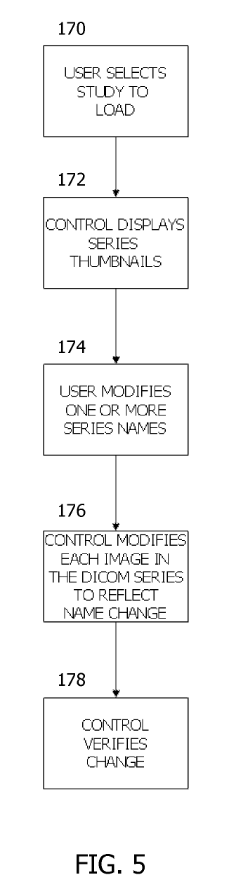

Similarly, as discussed above, embodiments may allow the user to manipulate the series names. Changing the series names can be very useful to an organization that has a naming standard but must accept outside images. Similar to above and as seen in the flowchart in FIG. 5, the user selects a study to load in block 170. The control running in the browser converts the DICOM image files into JPEG snapshots and presents the user with a preview of each series in block 172. The browser may display a button labeled ‘Rename Series’. Once clicked a window appears to the user with a list of the series and their current names in text fields. The user may then modify any of the values and click ‘Save’ in block 174. Similar to the process described above for moving images, for each series name that was changed, the control will load each DICOM image for the target series and modify the DICOM header SeriesDescription in block 176 and then verify the changes in block 178.

After any modifications of the DICOM studies, series, or image files, the user may then select which studies to transfer to the server as described above. Once the user makes this selection the control will convert the modified header data into an XML stream and may then use the browser control API to transfer the XML header data to the server. While the above examples utilize a control running in a browser on a local system to modify DICOM image files, the operations of moving DICOM image files, renaming series, or any other DICOM image header modifications may also be performed on the server after the DICOM images have been uploaded.

### C-STORE via Embedded Control

The DICOM standard provides a set of tools having a common language to transfer images between DICOM systems. One of the tools available to transfer DICOM image files from one system to another is C-STORE. Some embodiments of the invention embed the C-STORE functionality at the server incorporating a control in a browser. In one embodiment, the control is written to use a browser's integration API to load inline with a web page. When a user initiates a request, the server responds with an HTML page. The HTML page contains a call which causes the browser to load the control. The control allows the user to view the DICOM images in the browser directly from the server as illustrated with computer 70 in FIG. 1. The control also allows the user to manipulate the DICOM images, securely download images from the server using protocols such as HTTPs and SSL, and then perform a DICOM C-STORE to their own internal DICOM application such as a PACS or another DICOM Workstation as illustrated with computer 60 in FIG. 1.

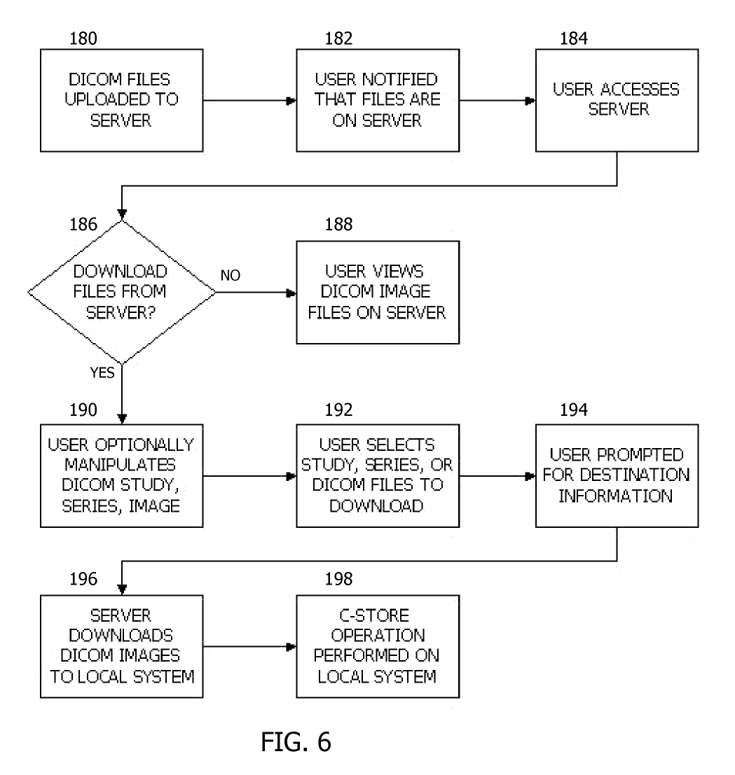

FIG. 6 is a flowchart of an embodiment for receiving DICOM image files and optionally downloading the files and performing a C-STORE on the local system through a browser. Referring to the flowchart in FIG. 6, after DICOM image files are uploaded to a server in block 180, a user is notified that the files are on the server in block 182. The user may then access the server in block 184 gaining access to the uploaded files. At this point, the user may decide whether or not do download the image files in block 186. If the user decided to not download the files (“no” branch of decision block 186), the user may view the DICOM images directly from the server in the browser in block 188. If the user decides to download the DICOM image files (“yes” branch of decision block 186), the user may then manipulate the images in block 190, modifying items such as series names, study or series memberships, etc. as described above. The user then selects the study, series, or DICOM files to download in block 192. To perform a C-STORE operation on the user's local system, the control will prompt the user to enter information about the destination such as AETitle, IP Address and Port in block 194. The server may then download the DICOM image files into memory on the local system in block 196 over a secure connection, such an SSL or using a HTTPs protocol. A C-STORE operation may then be initiated on the local system based on the image file list in memory in block 198.

### Computing Environment

Referring back to FIG. 1, server computer 40, as well as other computers 20, 60, 70, typically includes at least one processor 42 coupled to a memory 44. Processor 42 may represent one or more processors (e.g. microprocessors), and memory 44 may represent the random access memory (RAM) devices comprising the main storage of computer 40, as well as any supplemental levels of memory, e.g., cache memories, non-volatile or backup memories (e.g. programmable or flash memories), read-only memories, etc. In addition, memory 44 may be considered to include memory storage physically located elsewhere in computer 40, e.g., any cache memory in a processor 42, as well as any storage capacity used as a virtual memory, e.g., as stored on a mass storage device 46 or another computer coupled to computer 40 via a network 30.

Computer 40 also typically receives a number of inputs and outputs for communicating information externally. For interface with an administrator or operator, computer 40 typically includes one or more user input devices 50 (e.g., a keyboard, a mouse, a trackball, a joystick, a touchpad, a keypad, a stylus, and/or a microphone, among others). Computer 40 may also include a display 52 (e.g., a CRT monitor, an LCD display panel, and/or a speaker, among others). The interface to computer 40 may also be through an external terminal connected directly or remotely to computer 40, or more typically through other computers, such as computers 20, 60, 70, communicating with computer 40 via a network 30, modem, or other type of communications device.

Computer 40 operates under the control of an operating system 54, and executes or otherwise relies upon various computer software applications, components, programs, objects, modules, data structures, etc. (e.g. web application 56) collectively referred to as “objects”. Web application 56, for example, may temporarily store are transfer DICOM image files 48, which may contain image 14. Computer 40 communicates on the network 30 through a network interface 58.

In general, the routines executed to implement the embodiments of the invention, whether implemented as part of an operating system or a specific application, component, program, object, module or sequence of instructions will be referred to herein as “computer program code”, or simply “program code”. The computer program code typically comprises one or more instructions that are resident at various times in various memory and storage devices in a computer, and that, when read and executed by one or more processors in a computer, causes that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution. Examples of computer readable media include but are not limited to physical, recordable type media such as volatile and non-volatile memory devices, floppy and other removable disks, hard disk drives, optical disks (e.g., CD-ROM's, DVD's, etc.), among others, and transmission type media such as digital and analog communication links.

In addition, various program code described hereinafter may be identified based upon the application or software component within which it is implemented in specific embodiments of the invention. However, it should be appreciated that any particular program nomenclature that follows is merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, APIs, applications, applets, etc.), it should be appreciated that the invention is not limited to the specific organization and allocation of program functionality described herein.

Those skilled in the art will recognize that the exemplary environment illustrated in FIG. 1 is not intended to limit the present invention. Indeed, those skilled in the art will recognize that other alternative hardware and/or software environments may be used without departing from the scope of the invention.

While all of the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the applicant's general inventive concept.

What is claimed is:

1. A method for delivering DICOM images comprising:
accessing a plurality of files stored on a computer, the plurality of files including DICOM image files and non-DICOM image files;
identifying the DICOM image files from among the plurality of files by scanning header data of the plurality of files when accessing the plurality of files;
selecting at least one of the identified DICOM image files to be uploaded in response to user input; and
uploading the selected DICOM image file to an application on a server.

2. The method of claim 1 further comprising:
modifying a header of the selected DICOM image file prior to uploading.

3. The method of claim 2 further comprising:
executing a DICOM C-STORE command on the selected DICOM image file prior to uploading.

4. The method of claim 1 further comprising:
receiving notification that the selected DICOM image file has been uploaded; and
displaying a representation of the DICOM image by the application on the server.

5. The method of claim 1 further comprising:
receiving notification that the selected DICOM image file has been uploaded;
modifying DICOM image file header data associated with the uploaded DICOM image file; and
downloading the DICOM image file to a local system.

6. The method of claim 1 wherein identifying DICOM image files comprises:
reading header information, including metadata, of a file of the plurality of files;
checking the metadata for a DICOM prefix; and
in response to an existing DICOM prefix in the metadata, identifying the file as a DICOM image file.

7. The method of claim 1 further comprising:
reading header information, including metadata, from the identified DICOM image files;
extracting descriptive information from the metadata; and
presenting the descriptive information for each of the identified DICOM image files.

8. The method of claim 7 further comprising:
grouping the identified DICOM image files by a study identification extracted from the metadata; and
presenting the identified DICOM image files by group.

9. The method of claim 8 further comprising:
organizing the grouped DICOM image files by a series identification extracted from the metadata; and
presenting the DICOM image files by series within each group.

10. The method of claim 7 wherein the descriptive information includes information selected from the group consisting of patient identification, patient name, patient date of birth, type of image file, series identification, series description, study identification, image identification, and combinations thereof.

11. The method of claim 1 wherein uploading the selected DICOM image file comprises:
transmitting the selected DICOM image file over a secure network connection.

12. The method of claim 11 wherein the application on the server is a web application and wherein the transmission uses HyperText Transfer Protocol, secured.

13. The method of claim 11 wherein the secure network connection is a secured socket layer (SSL) of a TCP/IP protocol.

14. A method for receiving DICOM images comprising:
receiving notification that a DICOM image file has been uploaded to an application on a server; and
accessing the uploaded DICOM image file.

15. The method of claim 14 wherein accessing the uploaded DICOM image file comprises:
displaying a representation of the DICOM image by the application on the server.

16. The method of claim 14 wherein accessing the uploaded DICOM image file comprises:
modifying DICOM image file header data associated with the uploaded DICOM image file; and
downloading the DICOM image file to a local system.

17. The method of claim 16 further comprising:
executing a DICOM C-STORE command on the downloaded DICOM image file on the local system.

18. The method of claim 16 further comprising:
displaying the downloaded DICOM image file on the local system.

19. An apparatus comprising:
a processor; and
program code configured to be executed by the processor for delivering DICOM images, the program code resident in the memory and configured to access a plurality of files stored on a computer, the plurality of files including DICOM image files and non-DICOM image files, identify the DICOM image files from among the plurality of files by scanning header data of the plurality of files when accessing the plurality of files, select at least one of the identified DICOM image files to be uploaded in response to user input, and upload the selected DICOM image file to an application on a server.

20. The apparatus of claim 19 wherein the program code is further configured to:
receive notification that the selected DICOM image file has been uploaded, and display a representation of the DICOM image by the application on the server.

21. The apparatus of claim 19 wherein the program code is further configured to:
receive notification that the selected DICOM image file has been uploaded, modify DICOM image file header data associated with the uploaded DICOM image file, and download the DICOM image file to a local system.

22. The apparatus of claim 19 wherein the program code is configured to identify DICOM image files by:
reading header information, including metadata, of a file of the plurality of files;
checking the metadata for a DICOM prefix; and
in response to an existing DICOM prefix in the metadata, identifying the file as a DICOM image file.

23. A program product, comprising:
a computer readable medium; and
a program code configured to receive DICOM images, the program code resident on the computer readable medium and configured to receive notification that a DICOM image file has been uploaded to an application on a server, and access the uploaded DICOM image file.

24. The program product of claim 23 wherein the program code is configured to access the uploaded DICOM image file by:
displaying a representation of the DICOM image by the application on the server.

25. The program product of claim 23 wherein the program code is configured to access the uploaded DICOM image file by:
modifying DICOM image file header data associated with the uploaded DICOM image file; and
downloading the DICOM image file to a local system.
